(19) United States
(12) Patent Application Publication
(10) Pub. No.: US 2023/0321887 A1
(43) Pub. Date: Oct. 12, 2023

(54) Device and Method for Controlling the Feed of Polymer Melt to a Plastics Processing Machine

(71) Applicant: FEDDEM GmbH & Co. KG, Sinzig (DE)

(72) Inventors: Dieter Gross, Pfungstadt (DE); Sebastian Jost, Wehr (DE); Andreas Stuber, Bad Breisig (DE)

(21) Appl. No.: 18/028,731

(22) PCT Filed: Sep. 7, 2021
(86) PCT No.: PCT/EP2021/074598

§ 371 Date: Mar. 27, 2023

(30) Foreign Application Priority Data
Sep. 28, 2020 (EP) 20198670.0

(51) Int. Cl. B29C 48/92; B29B 11/10; B29B 11/16; B29C 48/695; B29C 48/37

(52) U.S. Cl. CPC B29C 48/92; B29B 11/10; B29B 11/16; B29C 2948/92876; B29C 48/37; B29C 2948/926; B29C 2948/92514; B29C 48/695

(57) ABSTRACT

The invention relates to a device and a method for controlling the feed of polymer melt, which has been discharged from an extruder, to a plastics processing machine formed from at least two subunits (1, 2), to which the polymer melt discharged from the extruder is fed via a distributor (13) which is positioned downstream of the extruder and which serves for splitting up the polymer melt into partial streams corresponding to the number of subunits. According to the invention, the partial streams are each fed to a subunit by means of a gearwheel pump (11, 12). The volume flows fed to the subunits (1, 2), which are of substantially identical design, can be respectively separately controlled in open-loop or closed-loop fashion through control of the drive rotational speed of the respective gearwheel pump (11, 12) in a manner dependent on operating parameters and/or the configuration of the respective subunit (1, 2).

The invention relates to a device for controlling the feed of polymer melt discharged from an extruder to a plastics processing machine according to the preamble of claim 1 and a method for controlling the distribution of a polymer melt discharged from an extruder to at least two subunits of a plastics processing machine according to the preamble of claim 10.

Plastics processing machines are typically supplied from an extruder which outputs a polymer strand which is fed to the plastics processing machine for further processing and product manufacture in which strand products are formed such as tubes, films, rods, or the like. For some purposes, a plastics processing machine can also contain several nozzle heads, for example for the production of multi-layer films. For this purpose, the polymer strand emerging from the extruder is split up into several partial streams via a distributor, which are fed to the separate nozzle heads. Here it is possible to adjust the partial flows individually depending on the required throughput in the nozzle heads. For this purpose, gearwheel pumps can be connected downstream of the distributor, the drive speed of which can be adjusted. Gearwheel pumps usually reduce the existing pulsation of the extruder and build up the required delivery pressure for the plastics processing machine. Depending on the viscosity of the plastic melt, gearwheel pumps can be operated in different ways to achieve the highest possible volumetric efficiency.

Known corresponding devices operate in a static manner following suitable pre-adjustment.

EP 3 470 196 A1 discloses a device and a method for impregnating fiber bundles with a polymer melt, in which the polymer melt discharged from an extruder is fed to at least two subunits of an impregnation unit in which the introduced fiber strands are impregnated with polymer melt. In each subunit, a large number of fiber strands are impregnated in parallel to one another. The number of fiber strands per subunit can vary. Furthermore, the fiber strands can have different chemical or physical properties, which requires variable, constant, dynamic adaptation of the polymer strands fed to the subunits to the properties of the fiber strands and the current processing parameters during impregnation.

The invention is therefore based on the object of specifying a device for controlling the feed of polymer melt discharged from an extruder and split up via a distributor to a plastics processing machine, which makes it possible to flexibly adjust and dynamically regulate the operating parameters of the subunits of the plastics processing machine.

The invention is also based on the object of specifying a method for controlling the distribution of a polymer melt discharged from an extruder over at least two subunits of a plastics processing machine for impregnating rows of fiber strands, in which the feed of the polymer melt to the subunits is variable and dynamically controllable depending on the operating parameters of the respective subunit.

These objects are attained by the invention specified in claims 1 and 10, respectively. Further developed embodiments of the invention are specified in the dependent claims.

The device according to the invention is based on a device for controlling the feed of polymer melt discharged from an extruder to a plastics processing machine. This contains at least two subunits, to which the polymer melt discharged from the extruder is fed via a distributor downstream of the extruder for splitting up the polymer melt into a number of partial streams, which corresponds to the number of subunits.

According to the invention, the partial flows are each supplied to the subunits by means of a gearwheel pump, wherein the volume flows supplied to the subunits, which are essentially of the same design, can be separately controlled in open-loop or closed-loop fashion by controlling the drive speed of the respective gearwheel pump depending on operating parameters and/or the equipment of the respective subunit.

By using gearwheel pumps for each subunit of a plastics processing machine, precise but variable control of the feed of polymer melt to the subunits can be achieved. The feed quantity and the pressure can be controlled by detecting various parameters in the subunits while controlling the speed of the gearwheel pumps separately for each subunit depending on the parameters detected.

The recorded parameters are preferably the type, temperature, and pressure of the polymer melt that is fed to the gearwheel pumps, the temperature in the working space of the subunits, the degree of filling and the pressure in the respective subunit, and the properties of the respective subunit products to be processed.

The pressure in the respective subunit is preferably regulated to a preset target value.

The invention is preferably used in a plastics processing machine for impregnating fiber bundles with plastic polymer discharged from an extruder, wherein the plastics processing machine contains at least two subunits operated in parallel for an identical or different number of fiber bundles.

Plastics processing machines of the type mentioned above are used to impregnate bundles of continuous fibers with plastic polymer, then to divide the impregnated strands into pellets and feed them to subsequent devices for the production of high-strength strand products or molded parts. A plastics processing machine with several subunits allows the subunits to be operated independently of one another, in particular with a different number of fiber bundles, different densities and types of fibers, different processing parameters, and different temperatures. The parameters or setting values of the subunits detected via sensors are preferably supplied to an open-loop or closed-loop control unit, via which a setting value is determined for setting the drive speed of the gearwheel pumps assigned to the subunits.

Similar types of pumps, preferably worm or screw pumps, can also be used instead of gearwheel pumps.

To achieve a sufficient feed pressure at low dispensing pressures of the extruder used to produce the polymer melt at the inlet of the distributor for distribution of the polymer melt to the gearwheel pumps used, the distributor is preferably connected upstream of a booster pump with which the inlet pressure of all gearwheel pumps can be increased uniformly and also pressure losses in the distributor, the gearwheel pumps and pipeline between the extruder and distributor can be balanced.

Preferably, the gearwheel pumps each contain a bypass connection, which can be throttled if necessary, between the inlet and outlet, via which part of the polymer melt is fed directly to the subunits of the plastics processing machine, bypassing the passage.

Alternatively, the gearwheel pumps can preferably be operated as pumps with a negative or positive pressure difference between the inlet and outlet. To convert the gearwheel pumps accordingly, their shaft bearings can be exchanged, whereby a return flow formed therein is assigned to either the feed side or the discharge side of the pump.

The invention also relates to a method for controlling the distribution of a polymer melt discharged from an extruder over at least two subunits of a plastics processing machine for impregnating rows of fiber strands running parallel to one another through the impregnation chambers of the subunits, in which the fiber strands are supplied with the polymer melt to be impregnated therewith as they pass through the impregnation chambers.

According to the invention, the polymer melt discharged from the extruder is split up into at least two partial streams by means of a distributor, which are each fed to the subunits by means of a gearwheel pump, wherein the drive speed of the gearwheel pumps is dynamically controlled depending on the operating parameters of the respective subunits.

The drive speed of the respective gearwheel pump is preferably regulated in such a way that a target operating pressure in the impregnation chamber of the respective subunit is kept constant.

The drive speed of the respective gearwheel pump is preferably determined by determining one or more operating parameters of the subunits, which are selected from the parameters of the temperature of the impregnation chambers of the subunits, the temperature of the volume flows supplied to the gearwheel pumps, the filling level of the subunits, the pressure of the volume flows supplied to the subunits, the properties and the number of fiber bundles per subunit, the draw-off speeds of the fiber bundles from the subunits, and the physical or chemical properties of the polymer melt.

The invention is explained in more detail below using an exemplary embodiment for two subunits. In the following:

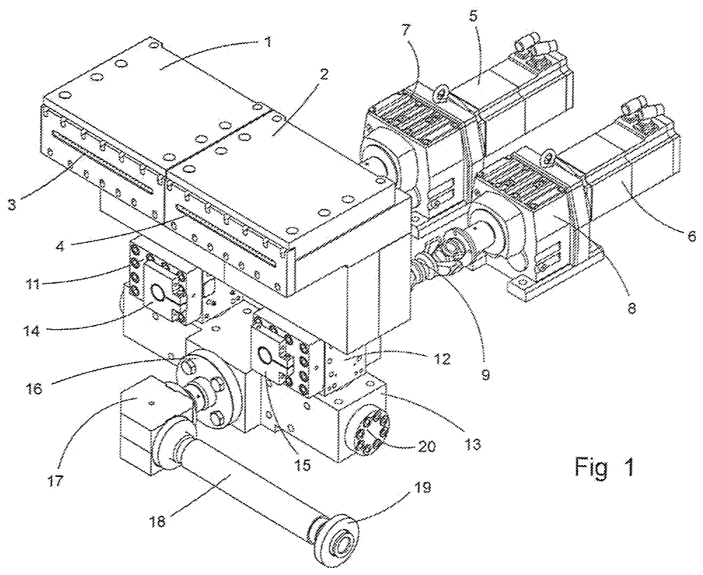

FIG. 1 shows a simplified perspective view of a plastics processing machine with melt feed,

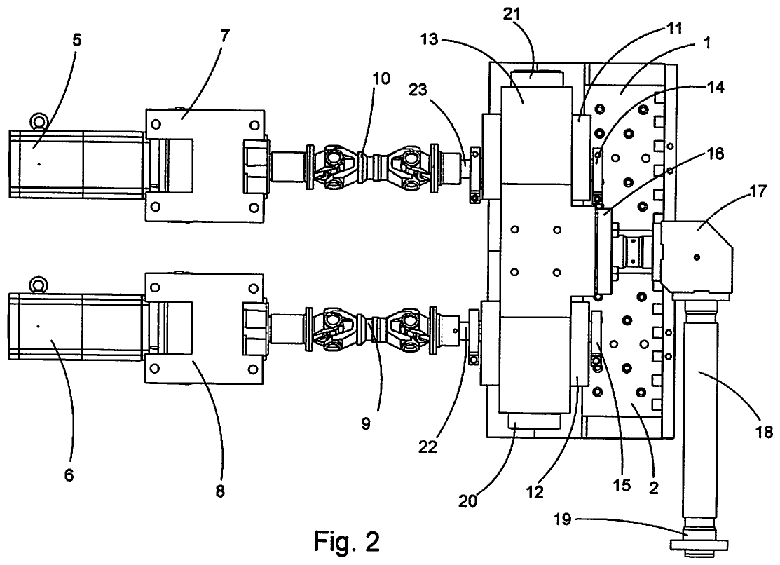

FIG. 2 shows a bottom view of a machine according to FIG. 1,

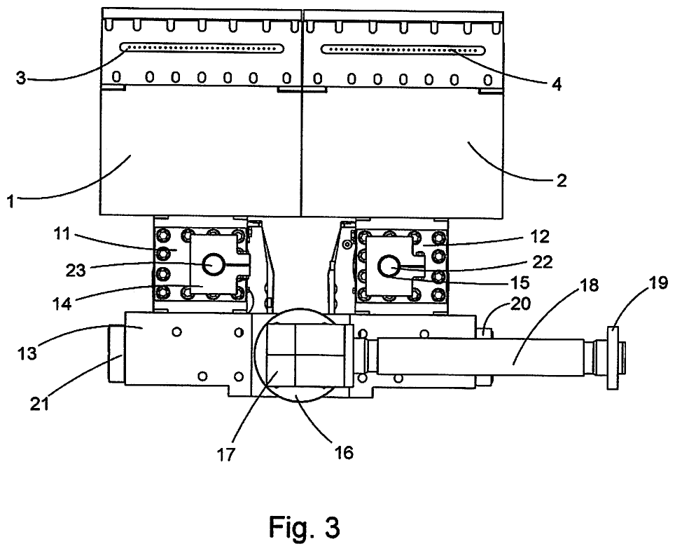

FIG. 3 is a front view of a machine according to FIG. 1.

The plastic processing machine shown in FIG. 1 serves to impregnate fiber strands with plastic polymer. The fiber bundles are fed in parallel to each other into a gap of the machine and become saturated with plastic polymer as they pass through the gap. The machine comprises two subunits 1 and 2 which are arranged parallel to one another and can be operated essentially independently of one another. Such a plastics processing machine is disclosed in EP 3470196 A1, the content of which is referred to.

The invention is not limited to use on two subunits, but also includes a larger number of subunits. The invention is also suitable for a large number of plastics, such as polymers, in particular polyamides (PA), polyolefins (PP), polyesters and other engineering plastics.

In FIG. 1, subunit 1 has a nozzle outlet 3 and subunit 2 has a nozzle outlet 4, from which the impregnated fiber bundles leave the subunits.

The polymer melt to be fed to the subunits is supplied by an extruder, not shown. The polymer melt reaches a distributor 13 via a flange 19, the pipeline 18, a deflection 17, and a flange 16, in which it is split up into two partial streams which enter two gearwheel pumps connected to the distributor. The distributor 13 is a passive distributor which splits the incoming melt and directs it to separate outlets to which feed pumps are connected. The distributor has inspection covers 20 and 21 for maintenance.

The gearwheel pumps 11 and 12 connected to the outlets of the distributor 13 are driven via motor drives with electric motors 5, 6 and gears 7, 8. To compensate for mounting tolerances or for local adjustment, the motor drives can contain cardan shafts 9 and 10, via which the gearwheel pumps 11 and 12 are driven.

To cool the shafts 22 and 23 of the gearwheel pumps, these have front cooling seals 14 and 15, which are designed as liquid-cooled shaft seals.

FIG. 2 shows a view from below of the device according to the invention, which shows the arrangement of the distributor 13 below the two subunits of the plastics processing machine.

FIG. 3 shows a front view of the device. The figure shows the compact structure, in which the distributor 13, the gearwheel pumps 11 and 12 and the subunits 1 and 2 of the plastics processing machine are directly interconnected over a short distance to keep the path of the polymer melt as short as possible.

To regulate the drive speed of the gearwheel pumps, which is preferably between 5 and 150 rpm, an open-loop or closed-loop control unit, not shown, is provided which is connected to a series of sensors which are arranged in the distributor, the gearwheel pumps and the subunits, in particular for recording the working pressures, temperatures, and relevant properties of the products to be processed and to regulate the delivery volume of the pumps and the pressure there. Furthermore, target values and fixed parameters for the type and quantity of the products to be processed can be set in the open-loop or closed-loop control unit.

### REFERENCE SYMBOLS

1 Subunit
2 Subunit
3 Nozzle outlet
4 Nozzle outlet
5 Electric motor
6 Electric motor
7 Gears
8 Gears
9 Cardan shaft
10 Cardan shaft
11 Gearwheel pump
12 Gearwheel pump
13 Distributor
14 Cooling seal
15 Cooling seal
16 Flange
17 Deflection
18 Pipeline
19 Flange
20 Inspection cover
21 Inspection cover
22 Shaft
23 Shaft

1. A device for controlling the feed of polymer melt discharged from an extruder to a plastics processing machine, which is formed from at least two subunits (1, 2) to which is supplied the polymer melt discharged from the extruder via a distributor (13) downstream of the extruder for splitting up the polymer melt partial flows corresponding to the number of subunits, characterized in that the partial flows are each supplied to a subunit by means of a gearwheel pump (11, 12) and that the volume flows supplied to the substantially identically designed subunits (1, 2) are controlled by controlling the drive speed of the respective gearwheel pump (11, 12) depending on the operating parameters, and/or the equipment of the respective subunit (1, 2) can each be separately controlled in open-loop or closed-loop fashion.

2. The device according to claim 1, characterized in that the operating parameters are at least selected from the type and temperature of the polymer melt supplied to the respective gearwheel pump (11, 12), the temperature in the working space of the subunits (1, 2), the filling level and pressure in the respective subunit, and the properties of the products to be processed in the respective subunit.

3. The device according to claim 2, characterized in that the volume flows are controlled in such a way that the pressure in the respective subunit is regulated to a preset target value.

4. The device according to claim 1, characterized in that the plastics processing machine is a device for impregnating fiber bundles with plastic polymer discharged from an extruder, wherein the device is designed to have at least two subunits (1, 2) operated in parallel for an identical or different number or type of fiber bundles.

5. The device according to claim 4, characterized in that the subunits (1, 2) each contain sensors for detecting one or more operating parameters, selected at least from sensors for detecting the temperature of the impregnation chambers of the subunits (1, 2), the temperature of the volume flows, the filling level of the subunits (1, 2), the pressure of the volume flows supplied to the subunits (1, 2), the properties and the number of fiber bundles per subunit, the draw-off speed of the fiber bundles from the subunits (1, 2), the properties of the polymer melt, and that the detected operating parameters are fed to an open-loop or closed-loop control unit via which the drive speed of the respective gearwheel pumps (11, 12) is dynamically adjusted.

6. The device according to claim 1, characterized in that the gearwheel pumps (11, 12) are designed as worm pumps or screw pumps.

7. The device according to claim 1, characterized in that between the extruder and distributor there is a pressure booster pump which can be used to compensate for pressure losses in the polymer melt occurring in the distributor (13), at gearwheel pumps (11, 12), and pipelines (18).

8. The device according to claim 1, characterized in that the gearwheel pumps (11, 12) have a bypass connection between the inlet and outlet, via which part of the supplied polymer melt is fed directly to the subunits (1, 2) of the plastics processing machine, bypassing the pump passage.

9. The device according to claim 4, characterized in that the gearwheel pumps (11, 12) can be operated as pressure boosting pumps with a positive or negative pressure difference between the inlet and outlet by changing the gear bearing with reference to the working pressure of the subunits (1, 2).

10. A method for controlling the distribution of a polymer melt discharged from an extruder over at least two subunits (1, 2) of a plastics processing machine for impregnating rows of fiber strands passing through impregnation chambers of the subunits (1, 2) parallel to one another, in which the fiber strands during their passage through the impregnation chambers are impregnated with the supplied polymer melt, characterized in that the polymer melt discharged from the extruder is split up into at least two partial flows by means of a distributor (13), which are each fed to the subunits (1, 2) by means of a gearwheel pump, wherein the drive speed of the gearwheel pumps (11, 12) is dynamically controlled as a function of the operating parameters of the respective subunits (1, 2).

11. The method according to claim 10, characterized in that the drive speed of the respective gearwheel pump is regulated in such a way that a target operating pressure in the impregnation chamber of the respective subunit is kept constant.

12. The method according to claim 10, characterized in that the drive speed of the respective gearwheel pump is determined by determining one or more operating parameters of the subunits (1, 2), which are selected from the parameters of the temperature of the impregnation chambers of the subunits (1, 2), the temperature of the volume flows, the filling level of the subunits (1, 2), the pressure of the volume flows supplied to the subunits, the properties and the number of fiber bundles per subunit, the draw-off speeds of the fiber bundles from the subunits (1, 2), as well as the physical or chemical properties of the polymer melt.

13. The method according to claim 10, characterized in that the gearwheel pumps (11, 12) are designed as worm pumps or screw pumps.
